(19) United States
(12) Patent Application Publication
(10) Pub. No.: US 2023/0409767 A1
(43) Pub. Date: Dec. 21, 2023

(54) METHOD OF OPTIMIZING A DESIGN OF A STRUCTURE BY CONSIDERING CENTRIFUGAL LOADS AND STRESS CONSTRAINTS

(71) Applicant: XIAMEN UNIVERSITY, FUJIAN (CN)

(72) Inventors: Cheng YAN, FUJIAN (CN); Ce LIU, FUJIAN (CN); He LIU, FUJIAN (CN); Yuxin LIN, FUJIAN (CN); Cunfu WANG, FUJIAN (CN); Zeyong YIN, FUJIAN (CN)

(73) Assignee: XIAMEN UNIVERSITY, FUJIAN (CN)

(21) Appl. No.: 18/169,144

(22) Filed: Feb. 14, 2023

(30) Foreign Application Priority Data
Jun. 10, 2022 (CN) 202210655155.3

(51) Int. Cl. G06F 30/13

(52) U.S. Cl. CPC G06F 30/13

(57) ABSTRACT

Disclosed is design optimization method of the structure considering centrifugal loads and stress constraints. Compared with the prior art, this application improves the method for obtaining the relaxation coefficient c, including the calculation of the second predicted maximum stress based on the predicted stress method from steps S9.1 to S9.8. The influence of the existence of jagged boundaries and gray densities on the calculation of the structural stress field is reduced. The most important thing is to decide whether to use linear penalty or nonlinear penalty for the elastic modulus of each element according to the ratio of the number of elements with design variables less than 0.1 and greater than 0.9 to the total number of elements. Introducing the predicted maximum stress can make full use of the allowable stress of materials, improve the quality of optimization design, and obtain a design scheme with a lighter mass.

### CROSS REFERENCE

This application claims a priority to Chinese Patent Application serial no. 202210655155.3, filed on Jun. 10, 2022. The entirety of the above-mentioned patent application is hereby incorporated by reference herein and made a part of this specification.

### TECHNICAL FIELD

The application relates to the field of structural design, particularly to a design optimization method of structures considering centrifugal loads and stress constraints.

### BACKGROUND

The turbine disk is an important load-bearing component of an aero-engine. The weight of the turbine disk is directly related to the structure's efficiency. The lighter turbine disk can improve the thrust-weight ratio of the aero-engine. Therefore, the lightweight design of the turbine disk is required.

At present, the shape optimization design of the traditional disk with a single web is very mature, and it is difficult to improve the structural performance of the turbine disk. As a powerful conceptual design tool, topology optimization is widely used in industrial manufacturing. A novel structure with a lighter weight can be obtained by using topology optimization techniques to optimize the turbine disk. The rapid development of additive manufacturing technology provides technical support for manufacturing complex configurations. Topology optimization can find the optimal material distribution in a given design domain by maximizing or minimizing the given objective function under assigned constraints.

In the prior art, topology optimization based on the variable density method has been applied to the design of uncomplicated industrial products. However, in the design process of the turbine disk considering centrifugal loads and stress constraints, the maximum stress value in the structure is often less than 70% of the allowable stress value of materials in the optimal design; that is, there is still a large margin to reduce the mass of turbine disk. The applicant finds that the topology optimization based on the variable density method needs to smooth the structure on the basis of the optimal variable set in the last step. However, due to the existence of jagged boundaries and fuzzy regions at the boundaries of the optimal variable set formed by iterative optimization, the smooth process often makes the optimized result far away from the original stress constraint conditions. At the same time, the presence of centrifugal loads and the use of the SIMP method to punish Von Mises stress in step S7 will result in low sensitivity of low-density elements, which is not conducive to topology optimization. Therefore, the effect of the variable density method applied to the structure analysis under centrifugal loads and stress constraints is unsatisfactory.

### SUMMARY

The following is an overview of the subject described in detail in this application. It is not intended to limit the scope of protection of the claims.

A method of optimizing a design of a structure by considering centrifugal loads and stress constraints, with the optimization objective of minimizing the structure mass under the stress constraints, including, a step of discretizing the structure in the design domain, a step of initializing the design variables xₑ of discrete elements to form the initial design variable set, a step of using the density method to carry out an iterative design until the optimal design variable set is obtained, and a step of smoothing the structure according to the optimal design variable set; the design variables xₑ of all elements in all design variable sets satisfy 0≤xₑ≤1; wherein each iteration of the design executes the following steps:
S1: obtaining a filtered density \tilde{p}ₑ of an element, based on the initial design variable set or the design variable set formed in the last iteration, by filtering the design variables of each element with the density filtering method;
S2: obtaining a first density ρₑ₁ by employing the Heaviside projection function to map the filtered density \tilde{p}ₑ of each element;

$${ρ}_{e 1} = \frac{tanh ( 0.5 {β}_{1}^{k} ) + tanh ( {β}_{1}^{k} ( {\tilde{ρ}}_{e} - 0.5 ) )}{2 tanh ( 0.5 {β}_{1}^{k} )} ;$$

where β₁^{k} is used to control smoothness of mapping curves, k is the sequence number in this iteration; when k=1, β₁^{k}=4; iteration updates are performed every 20 times from the first iteration and the value of β₁^{k} is 1.19 times the previous value of β₁^{k}; a maximum value of β₁^{k} is set to 8;
S3: calculating a first elastic modulus Eₑ₁ of each element by the rational approximation of material properties (RAMP) method;

$${E}_{e 1} = {E}_{min} + \frac{{ρ}_{e 1}}{1 + {q}_{1} ( 1 - {ρ}_{e 1} )} ( {E}_{max} - {E}_{min} ) ;$$

where Eₘₐₓ is an elastic modulus of a material, and Eₘᵢₙ is a value added to avoid the matrix singularity, q₁ is the first stiffness penalty factor, and q₁=4;
S4: assembling the global stiffness matrix, and calculating the structural displacement according to the static equilibrium equation;
S5: calculating the first stress σₑ₁ of each element;
S6: calculating the first von Mises stress σ_{VM1} of each element;
S7: obtaining a first penalty stress σ̅_{VM1} of each element by punishing a first von Mises stress σ_{VM1} of each element by using the RAMP method;

$${\overline{σ}}_{V M 1} = ( {E}_{min} + \frac{{ρ}_{e 1}}{1 + {q}_{2} ( 1 - {ρ}_{e 1} )} ( {E}_{max} - {E}_{min} ) ) {σ}_{V M 1} ;$$

where q₂ is the second stiffness penalty factor, and q₂=−0.95;
S8: obtaining an aggregate stress \tilde{σ} by aggregating the first penalty stress σ̅_{VM1} of each element;
S9: relaxing the stress constraints, wherein the formulation of stress relaxation is c·\tilde{σ}=σₗ, σₗ is a yield stress of the material, c is a relaxation coefficient in this iteration and is updated every five iterations, the formulation of c is

$$c = \frac{{\overline{σ}}_{p}^{k}}{\tilde{σ}} ,$$

σ̅ₚ^{k} is the first maximum predicted stress in this iteration;

$${\overline{σ}}_{p}^{k} = \{ \begin{matrix}{σ}_{p}^{k} , & k = 1 \\ 0.4 {σ}_{p}^{k} + 0.6 {σ}_{p}^{k - 1} , & k > 1\end{matrix} ;$$

where σₚ^{k} is the second maximum predicted stress, acquired by the following steps:
S9.1: obtaining a second density ρₑ₂ by employing a Heaviside projection function to map the filtered density \tilde{ρ}ₑ of each element;

$${ρ}_{e 2} = \frac{tanh ( 0.5 {β}_{2}^{k} ) + tanh ( {β}_{2}^{k} ( {\tilde{ρ}}_{e} - 0.5 ) )}{2 tanh ( 0.5 {β}_{2}^{k} )} ;$$

where β₂^{k} is used to control the smoothness of the mapping curves; when k=1, β₂^{k}=4; iteration updates are performed every 20 times from the first iteration and the value of β₂^{k} is the last value of β₂^{k} plus 4; a maximum value of β₂^{k} is 20;
S9.2: calculating the transition factor φ:

$$φ = \frac{{N}_{b} + {N}_{w}}{N} ;$$

where N is the total number of elements, N_{b} is the number of elements with the second predicted density ρₑ₂ greater than the first threshold, and N_{w} is the number of elements with the second predicted density less than the second threshold; the first threshold is greater than 0.75, and the second threshold is less than 0.25;
S9.3: calculating the second elastic modulus Eₑ₂ of each element;

$${E}_{e 2} = \{ \begin{matrix}{E}_{min} + \frac{{ρ}_{e 2}}{1 + {q}_{1} ( 1 - {ρ}_{e 2} )} ( {E}_{max} - {E}_{min} ) , & φ < 0.9 \\ {E}_{min} + {ρ}_{e 2} ( {E}_{max} - {E}_{min} ) , & φ \geq 0.9\end{matrix} ;$$

S9.4: assembling the global stiffness matrix, and calculating the structural displacement according to the static equilibrium equation;
S9.5: calculating the second stress σₑ₂ of each element;
S9.6: calculating the second von Mises stress σ_{VM2} of each element;
S9.7: obtaining a second penalty stress σ̅_{VM2} of each element by punishing the second von Mises stress σ_{VM2} of each element by using the linear method;

σ̅_{VM2}=(Eₘᵢₙ+ρₑ₂(Eₘₐₓ−Eₘᵢₙ))σ_{VM2};
S9.8: calculating the second maximum predicted stress σₚ^{k} in this iteration:

σₚ^{k}=max(σ̅_{VM2});
S10: conducting the sensitivity analysis of the objective function V_{f}:

$${V}_{f} = \frac{{\sum }_{e = 1}^{N} {ρ}_{e 1} {v}_{e}}{{\sum }_{e = 1}^{N} {v}_{e}} ;$$

where vₑ is the volume of the e-th element;
S11: obtaining and storing a design variable set formed in this iteration by moving asymptote algorithm (MMA) is used to solve the optimization problem and updating the design variables of each element;
S12: judging whether this iteration meets the exit iteration conditions, if this iteration meets the exit iteration conditions, exit the iteration, and record the design variable set formed in this iteration as the optimal design variable set; if the exit iteration conditions are not met, the next iteration will be carried out;
the above procedures from S9.1 to S9.8 allow parallel computation with those from S2 to S8.

Compared with the prior art, the above scheme has the following beneficial effects.

The main improvement of this invention is to improve the method for obtaining the relaxation coefficient c in step S9, including the calculation of of based on the predicted stress method from steps S9.1 to S9.8. The influence of the existence of jagged boundaries and gray densities on the calculation of the structural stress field is reduced. The most important thing is to decide whether to use linear penalty or nonlinear penalty for the elastic modulus of each element according to the ratio of the number of elements with design variables less than 0.1 and greater than 0.9 to the total number of elements. Introducing the predicted maximum stress can make full use of the allowable stress of materials, improve the quality of optimization design, and obtain a design scheme with a lighter mass than the prior art. Meanwhile, in step S7, the RAMP method is used to nonlinearly punish the Mises stress of each element. The penalty factor is set to −0.95, thus improving the sensitivity of low-density elements under centrifugal loads and stress constraints, and conducive to topology optimization.

### BRIEF DESCRIPTION OF THE DRAWINGS

In order to more clearly explain the technical solution of the embodiment, the required figure is briefly introduced as follows:

FIG. 1 is a flowchart of the design optimization method of this invention.

FIG. 2 is a body structure of the turbine disk of the embodiment.

FIG. 3 is a schematic diagram of the design domain and load conditions of the axisymmetric turbine disk of the embodiment.

FIG. 4 is a turbine disk structure constructed according to the optimal design variable set of the embodiment.

FIG. 5 is a smoothed structure of the turbine disk of the embodiment.

FIG. 6 is a Y-type axisymmetric structure of the verification example.

### DETAILED DESCRIPTION

The technical solutions in the embodiments will be described clearly and completely below in combination with the figures.

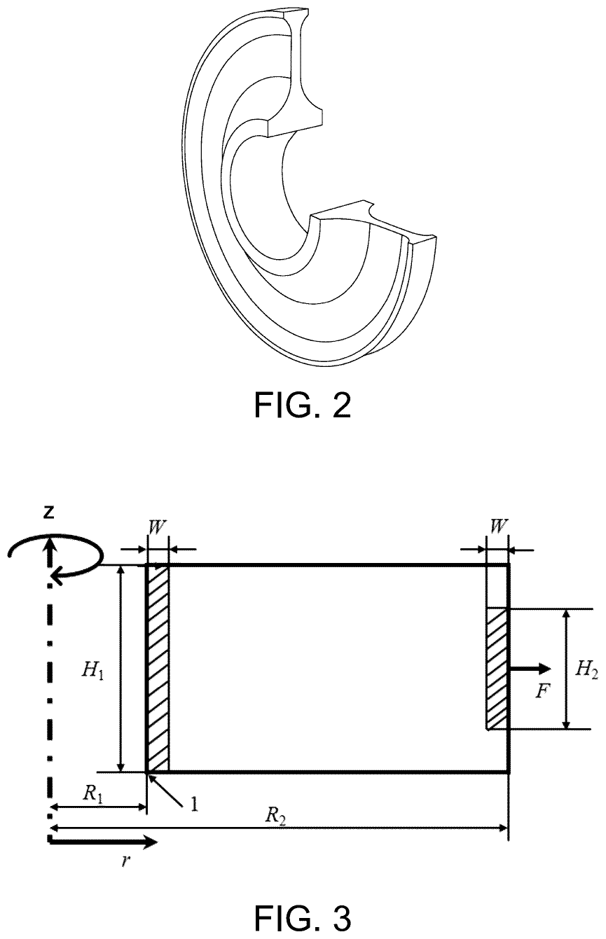

This embodiment relates to the design optimization of a turbine disk. The body structure of the turbine disc is shown in FIG. 2. When the aero-engine works, the turbine disk rotates at high speeds. The loads on the turbine disk mainly come from two aspects: on the one hand, the design-dependent centrifugal loads are generated by the high-speed rotation of the turbine disk itself, on the other hand, the fixed tensile loads on the outer radius of the turbine disk are caused by the high-speed rotation of turbine blades. The centrifugal loads generated by the turbine itself are symmetrical to the central rotation axis. The tensile loads are approximately evenly distributed on the disk rim surface. Therefore, the tensile loads are also considered to be symmetrical to the central rotation axis. The turbine disk is constrained only by the axial displacement. Thus, the turbine disk is an axisymmetric model. The original three-dimensional model can be further simplified to a two-dimensional axisymmetric model, which can significantly save computing resources and improve the efficiency of optimization design. Considering that topology optimization is a conceptual design, the existing design domain can be expanded to some extent.

FIG. 3 is the schematic diagram of the design area and load conditions of the axisymmetric turbine disk. The shaded areas are the non-design domains, and the blank area is the design domain. The geometry of the turbine disk is defined using the following parameters: R1=83 mm is the inner radius of the turbine disk; R2=237 mm is the outer radius of the turbine disk; H1=92 mm refers to the inner width of the turbine disk; H2=40 mm refers to the outer width of the turbine disk; W=2 mm is the thickness of the non-design domains. The turbine disk is made of linear elastic material: the Young's modulus is 192 GPa, the density is 8240 kg/m³, the Poisson's ratio is 0.3, and the yield stress of the material is 1000 MPa. The rotation velocity is set to 10000 r/min. The tensile loads caused by the high-speed rotation of turbine blades are set to 100 MPa and applied at the area where F is located. The axial displacement at point 1 is 0.

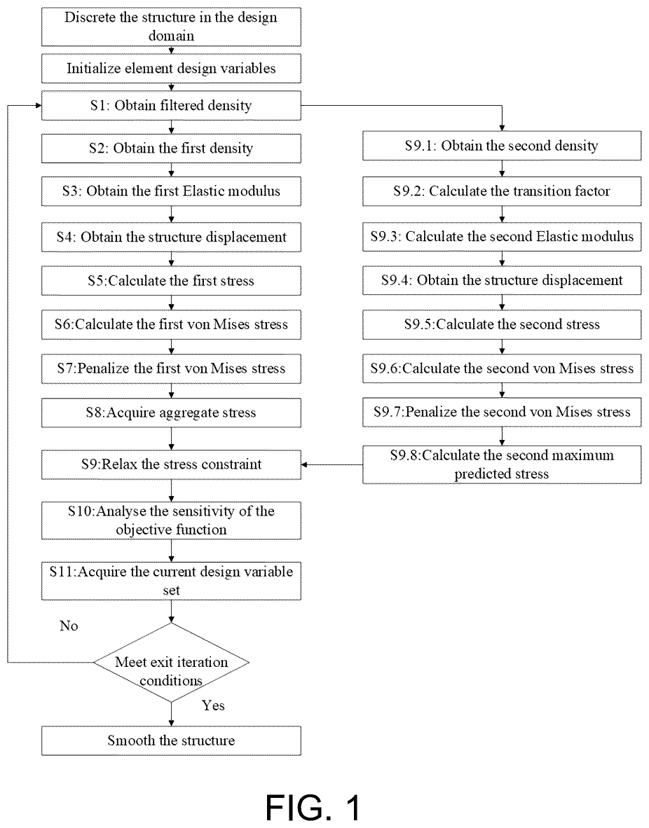

FIG. 1 shows the density method-based steps of the design optimization method for the above turbine disk structure considering centrifugal loads and stress constraints in this embodiment:
in the first step, using the finite element method, the structure is discretized by using the four-node rectangular axisymmetric element, the structure is discretized into N elements, each element corresponds to a design variable xₑ, the design variable xₑ should meet 0≤xₑ≤1, where e is the serial number of the element. All design variables are combined into a vector x. Considering the stress constraint, the minimum mass fraction of the structure is taken as the objective function, and the optimization objective can be expressed as:

$${min}_{x} {V}_{f} = \frac{{\sum }_{e = 1}^{N} {ρ}_{e 1} {v}_{e}}{{\sum }_{e = 1}^{N} {v}_{e}}$$

$$st \text{:} {σ}_{e} - {σ}_{l} \leq 0$$

$$0 \leq {x}_{e} \leq 1 , e = 1 , … , N$$

$$with : KU = F$$

where V_{f} is the structural mass fraction function (objective function). ρₑ₁ is the first physical density of the e-th element, which is the function of the design variable xₑ; vₑ is the volume of the e-th element, σₑ is the yield stress of the e-th element, and σₗ is the yield stress of the material; K is the global stiffness matrix of the combination, U is the displacement vector of the element node, and F is the equivalent load vector of the element node.

In the second step, the design variable xₑ of each element after discretization is initialized and forms the initial design variable set. In this embodiment, the initial values of the design variables in the design domain are set to 0.5, and the values of the design variables in the non-design domain are always set to 1.

In the third step, the density method is used for iterative design until the optimal design variable set is obtained; the following steps are executed for each iteration design:
S1: Obtaining the filtered density \tilde{p}ₑ of an element, based on the initial design variable set or the design variable set formed in the last iteration, by filtering the design variables of each element with the density filtering method. This step is a prior technique, and its implementation process is known to the technicians in the field. In this embodiment:

$${\tilde{ρ}}_{e} = \frac{{\sum }_{i ∈ N} w ( {x}_{i} ) {v}_{i} {x}_{i}}{{\sum }_{i ∈ N} w ( {x}_{i} ) {v}_{i}} ;$$

where w(xᵢ) is the weight coefficient representing the influence of the i-th element on the e-th element. It could be calculated as follows:

w(xᵢ)=max(0,rₘᵢₙ−∥cᵢ−cₑ∥₂);
where rₘᵢₙ is the given filter radius and is set to 3.5 in this embodiment; cᵢ is the center of the i-th element, and cₑ is the center of the e-th element.
S2: Obtaining the first density ρₑ₁ by employing the Heaviside projection function to map the filtered density pie of each element:

$${ρ}_{e 1} = \frac{tanh ( 0.5 {β}_{1}^{k} ) + tanh ( {β}_{1}^{k} ( {\tilde{ρ}}_{e} - 0.5 ) )}{2 tanh ( 0.5 {β}_{1}^{k} )} ;$$

where β₁^{k} is used to control the smoothness of mapping curves, k is the sequence number in this iteration; when k=1, β₁^{k}=4; iteration updates are performed every 20 times from the first iteration and the value of β₁^{k} is 1.19 times the previous value of β₁^{k}; the maximum value of β₁^{k} is set to 8.
S3: Calculating the first elastic modulus Eₑ₁ of each element by punish the elastic modulus of the element by the RAMP method:

$${E}_{e 1} = {E}_{min} + \frac{{ρ}_{e 1}}{1 + {q}_{1} ( 1 - {ρ}_{e 1} )} ( {E}_{max} - {E}_{min} ) ;$$

where Eₘₐₓ is the elastic modulus of the material, and Eₘᵢₙ is a small value added to avoid the matrix singularity, Eₘᵢₙ=1e⁻⁶Eₘₐₓ is selected in this embodiment; q₁ is the first stiffness penalty factor, and q₁=4.
S4: assembling the global stiffness matrix, and calculating the structural displacement according to the static equilibrium equation KU=F;
S5: calculating the first stress σₑ₁ of each element:

σₑ₁=DBu^{e};
where D is the elastic matrix of the axisymmetric element, B is the strain matrix of elements, and u^{e} is the shift matrix of elements.
S6: calculating the first von Mises stress (Von Mises stress) σ_{VM1} of each element:

σ_{VM1}=\sqrt{σₑ₁Vσₑ₁};
where V is the constant matrix, and it can be written as:

$$V = [ \begin{matrix}1 & - 0.5 & - 0.5 & 0 \\ - 0.5 & 1 & - 0.5 & 0 \\ - 0.5 & - 0.5 & 1 & 0 \\ 0 & 0 & 0 & 3\end{matrix} ] .$$

S7: Obtaining the first penalty stress σ̅_{VM1} of each element by punishing the first von Mises stress σ_{VM1} of each element by using the RAMP method:

$${\overline{σ}}_{VM 1} = ( {E}_{min} + \frac{{ρ}_{e 1}}{1 + {q}_{2} ( 1 - {ρ}_{e 1} )} ( {E}_{max} - {E}_{min} ) ) {σ}_{VM 1} :$$

where q₂ is the second stiffness penalty factor, and q₂=−0.95.
S8: Obtaining an aggregate stress \tilde{σ} by aggregating the first penalty stress σ̅_{VM1} of each element by using the P-norm method:

$$\tilde{σ} = {( \sum {( {\overline{σ}}_{VM 1} )}^{P} )}^{\frac{1}{P}} ;$$

where P is the norm factor and P=8 in this embodiment.
S9: Relaxing the stress constraint:
the formulation of stress relaxation is c·\tilde{σ}=σₗ;σₗ is the yield stress of the material, c is the relaxation coefficient in this iteration and is updated every 5 iterations, the formulation of c is

$$c = \frac{{\overline{σ}}_{p}^{k}}{\tilde{σ}} ,$$

σ̅ₚ^{k} is the first maximum predicted stress in this iteration:

$${\overline{σ}}_{p}^{k} = \{ \begin{matrix}{σ}_{p}^{k} , & k = 1 \\ 0.4 {σ}_{p}^{k} + 0.6 {σ}_{p}^{k - 1} , & k > 1\end{matrix} ;$$

where ok is the second maximum predicted stress, acquired by the following steps:
S9.1: obtaining the second density ρₑ₂ by employing the Heaviside projection function to map the filtered density \tilde{ρ}ₑ of each element;

$${ρ}_{e 2} = \frac{tanh ( 0.5 {β}_{2}^{k} ) + tanh ( {β}_{2}^{k} ( {\tilde{ρ}}_{e} - 0.5 ) )}{2 tanh ( 0.5 {β}_{2}^{k} )} ;$$

where β₂^{k} is used to control the smoothness of mapping curves; when k=1, β₂^{k}=4;iteration updates are performed every 20 times from the first iteration and the value of β₂^{k} is the last value of β₂^{k} plus 4; the maximum value of β₂^{k} is 20;
S9.2: calculating the transition factor φ:

$$φ = \frac{{N}_{b} + {N}_{w}}{N} ;$$

where N is the total number of elements, N_{b} is the number of elements with the second predicted density greater than the first threshold, and N_{w} is the number of elements with the second predicted density less than the second threshold, the first threshold is greater than 0.75, and the second threshold is less than 0.25. In this embodiment, the first threshold is set to 0.9, and the second threshold is set to 0.1.
S9.3: calculating the second elastic modulus Eₑ₂ of each element;

$${E}_{e 2} = \{ \begin{matrix}{E}_{min} + \frac{{ρ}_{e 2}}{1 + {q}_{1} ( 1 - {ρ}_{e 2} )} ( {E}_{max} - {E}_{min} ) , & φ < 0.9 \\ {E}_{min} + {ρ}_{e 2} ( {E}_{max} - {E}_{min} ) , & φ \geq 0.9\end{matrix} ;$$

S9.4: assembling the global stiffness matrix, and calculating the structural displacement according to the static equilibrium equation KU=F;
S9.5: calculating the second stress of each element σₑ₂. The method is the same as S5.
S9.6: Calculating the second von Mises stress of each element σ_{VM2}. The method is the same as S6.
S9.7: Obtaining the second penalty stress β₂^{k}_{VM2} of each element by punishing the second von Mises stress σ_{VM2} of each element by using the linear method.
S9.8: Calculating the second maximum predicted stress op in this iteration:

σₖ^{p}=max(σ̅_{VM2});

The above procedures from S9.1 to S9.8 allow parallel computation with those from S2 to S8. In this embodiment, both the procedures are calculated in parallel.
S10: Conducting the sensitivity analysis of the objective function V_{f}:
the formulation of sensitivity of the objective function is as follows:

$$\frac{\partial {V}_{f}}{\partial {ρ}_{e 1}} = \frac{{V}_{e}}{{\sum }_{e} {V}_{e}} ;$$

the sensitivity of the global stress constraint is calculated using the adjoint method:
the augmented form of the aggregate stress is written as

\tilde{\hat{σ}}=\tilde{σ}+λ^{T}(KU−F),
where λ is an arbitrary adjoint vector;
the sensitivity of the global stress is written as:

$$\frac{\partial {σ}^{\hat{\sim}}}{\partial {ρ}_{e}} = \frac{\partial \tilde{σ}}{\partial {ρ}_{e}} ++ {λ}^{T} ( \frac{\partial K}{\partial {ρ}_{e}} u - \frac{\partial F}{\partial {\overline{ρ}}_{e}} ) ;$$

$$where$$

$$\frac{\partial \tilde{σ}}{\partial {ρ}_{e}} = \frac{1}{P} {( \sum {( {\overline{σ}}_{e}^{VM} )}^{P} )}^{\frac{1}{P} - 1} {P ( {\overline{σ}}_{e}^{VM} )}^{P - 1} \frac{1 + {q}_{s}}{{( 1 + {q}_{s} ( 1 - ρ ) )}^{2}} ( {E}_{0} - {{E}_{min} ( )}_{e}^{VM} ) ;$$

$${λ}^{T} = - {K}^{- 1} ( \frac{1}{P} {( \sum {( {\overline{σ}}_{e}^{VM} )}^{P} )}^{\frac{1}{P} - 1} {P ( {\overline{σ}}_{e}^{VM} )}^{P - 1} ( E \frac{ρ}{1 + {q}_{s} ( 1 - ρ )} ( E {min}_{max} ) {\frac{1}{{σ}_{e}^{VM}}}_{{e}_{min}}^{T} ( ) ) ) ;$$

calculating the derivative of the physical density ρₑ to the design variable xₑ using the chain rule:

$$\frac{\partial {ρ}_{e}}{\partial {x}_{e}} = \frac{\partial {ρ}_{e}}{\partial {\tilde{ρ}}_{e}} \frac{\partial {\tilde{ρ}}_{e}}{\partial {x}_{e}} ,$$

S11: obtaining and storing a design variable set formed in this iteration by the moving asymptote algorithm (MMA) to solve the optimization problem and updating the design variables of each element;
S12: judging whether this iteration meets the exit iteration conditions, if this iteration meets the exit iteration conditions, exit the iteration, and record the design variable set formed in this iteration as the optimal design variable set; if the exit iteration conditions are not met, the next iteration will be carried out; specifically, the method to judge whether this iteration meets the exit iteration conditions is to compare the design variable set formed in this iteration with that in the last iteration, or compare the objective function value obtained in this iteration with that in the last iteration, and the second maximum predicted stress is less than or equal to the yield stress of the material. In this embodiment, the exit iteration condition is that the absolute value of the difference between all design variables in the design variable set formed in this iteration and that in the last iteration is less than the third threshold, which is set to 0.05. In this embodiment, it is also specified that the minimum iterative steps are 200 and the maximum iterative steps are 400.

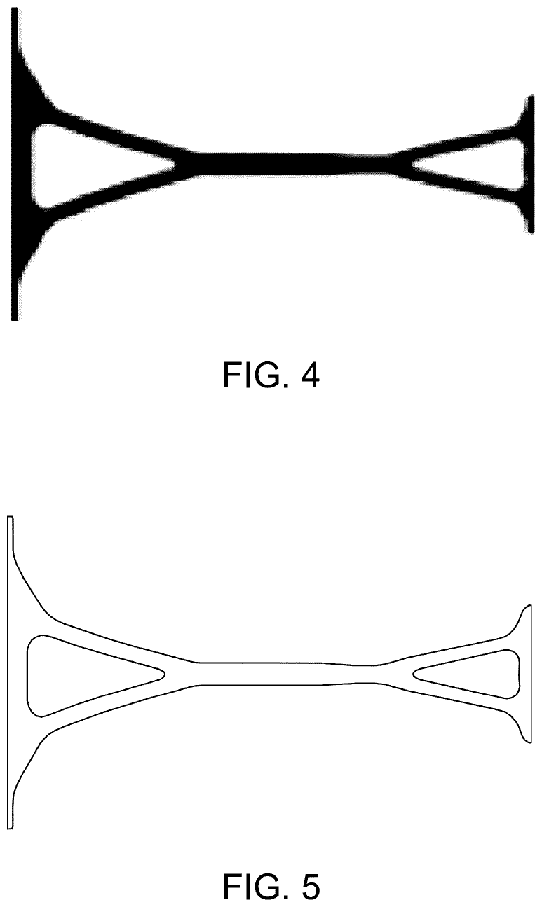

FIG. 4 shows the turbine disk structure constructed according to the optimal design variable set in the embodiment. The mass fraction of the optimized structure is 0.101. Compared with the original turbine disk, the mass of the structure is reduced by 48% with meeting the stress requirements.

In the fourth step, smoothing the structure according to the optimal design variable set. In this embodiment, the specific method is: for any element in the optimal design variable set, if xₑ<0.5, there is no material in the space where the element is located; if xₑ>0.5, the space where the element is located has all materials; if xₑ=0.5, then the element is located at the interface.

After smoothing, the obtained structure of the turbine disk is shown in FIG. 5. The finite element analysis of the reconstructed structure is carried out using the ANSYS software. The size of the mesh is set to 1 mm, and the total number of elements is 3012, as shown in FIG. 5. Using the same loads, boundary conditions and material properties, the maximum von Mises stress of the reconstructed structure is calculated as 1004 MPa. The relative stress error is 0.4%, which meets the operating requirements.

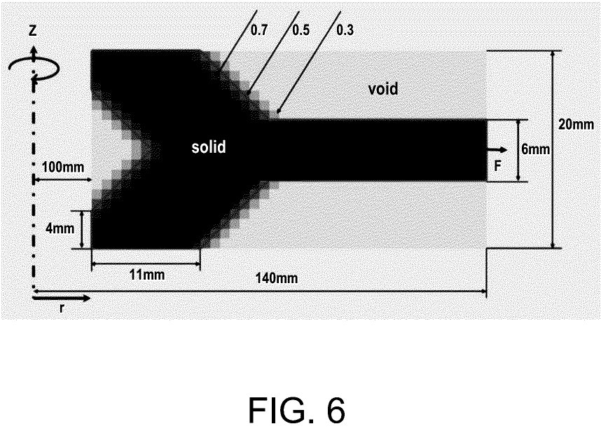

In addition to the embodiment, the applicant also verified the method of obtaining the first maximum predicted stress in step S9 and from steps S9.1 to S9.8. A Y-type axisymmetric structure of the verification example is shown in FIG. 6. The specific verification method is as follows.

FIG. 6 shows the detailed shape and size information of the selected Y-type axisymmetric structure with jagged boundaries and the region of gray densities. The physical density of elements in the void and solid areas are set to 0 and 1, respectively. The elements denoted by 0.3, 0.5, and 0.7 mean that the physical density of these elements are set to 0.3, 0.5, and 0.7, respectively. The rotation angular velocity of the structure is set to 1047.2 rad/s. The tensile loads are set to 100 MPa and applied at the edge with a length of 6 mm on the right side of the structure. The axial displacement constraint is set to 0 and applied at the lower left corner of the structure. The structure could be reconstructed by using grey lines to connect diagonals of elements with a density of 0.5 and boundaries of elements with a density of 1. As shown in FIG. 6, the structure enclosed by the grey sidelines is the reconstructed geometry model. The ANSYS software is used to generate the body-fitted mesh and then conduct the finite element analysis. The actual maximum stress of the Y-type axisymmetric structure is calculated as 366.95 MPa. Table 1 shows the predicted maximum stress of the Y-type axisymmetric structure using different values of the Heaviside parameter β₂^{k}, respectively calculated using the linear and nonlinear stiffness penalty schemes. It can be seen that: as the value of β₂^{k} in Heaviside function increases gradually, the maximum stress value obtained by using nonlinear punishment is always greater than that obtained by linear punishment; the maximum stress value obtained by linear punishment has less fluctuation and is close to the maximum stress value obtained by finite element analysis under the same element size in ANSYS.

TABLE 1
the relation between the value of β₂^{k} and the calculated stress

| | Nonlinear | Linear | |
|---|---|---|---|
| | penalty | penalty | ANSYS |
| β₂^{k} | (100 MPa) | (100 MPa) | (100 MPa) |
| 4 | 3.8767 | 3.6658 | 3.6695 |
| 8 | 3.7911 | 3.6610 | 3.6695 |
| 12 | 3.7554 | 3.6598 | 3.6695 |
| 16 | 3.7467 | 3.6595 | 3.6695 |
| 20 | 3.7480 | 3.6620 | 3.6695 |
| 25 | 3.7487 | 3.6631 | 3.6695 |

According to the above embodiment and verification examples, it can be seen that: compared with the prior art, the main improvements and technical effects of this invention are as follows. First, in step S9, the method for obtaining the relaxation coefficient c is improved, including the calculation of σₚ^{k} based on the predicted stress method from steps S9.1 to S9.8. The influence of the existence of jagged boundaries and gray densities on the calculation of the structural stress field is reduced. The most important thing is to decide whether to use linear penalty or nonlinear penalty for the elastic modulus of each element according to the ratio of the number of elements with design variables less than 0.1 and greater than 0.9 to the total number of elements. Introducing the predicted maximum stress can make full use of the allowable stress of materials, improve the quality of optimization design, and obtain a design scheme with a lighter mass than the prior art. Then, in step S7, the RAMP method is used to nonlinearly punish the Mises stress of each element. The penalty factor is set to −0.95, improving the sensitivity of low-density elements under centrifugal loads and stress constraints, and conducive to topology optimization.

The descriptions of the above instructions and embodiments are used to explain the scope of protection of this application, but does not constitute the limitations of the scope of protection of this application.

What is claimed is:

1. A method of optimizing a design of a structure by considering centrifugal loads and stress constraints, with an optimization objective of minimizing structure mass under the stress constraints, the method comprising:
a step of discretizing a structure in a design domain,
a step of initializing design variables xₑ of discrete elements to form an initial design variable set,
a step of using a density method to carry out an iterative design until an optimal design variable set is obtained, and
a step of smoothing the structure according to the optimal design variable set,
wherein the design variables xₑ of all elements in all design variable sets satisfy 0≤xₑ≤1,
wherein each iteration of the iterative design executes the following steps:
S1: obtaining a filtered density \tilde{p}ₑ of an element, based on the initial design variable set or the design variable set formed in a last iteration, by filtering the design variables of each element with a density filtering method;
S2: obtaining a first density ρₑ₁ by employing Heaviside projection function to map the filtered density \tilde{p}ₑ of each element;
$${ρ}_{e 1} = \frac{tanh ( 0.5 {β}_{1}^{k} ) + tanh ( {β}_{1}^{k} ( {\tilde{ρ}}_{e} - 0.5 ) )}{2 tanh ( 0.5 {β}_{1}^{k} )} ;$$
wherein β₁^{k} is used to control smoothness of mapping curves, k is a sequence number in this iteration; when k=1, β₁^{k}=4; iteration updates are performed every 20 times from the first iteration and the value of β₁^{k} is 1.19 times the previous value of β₁^{k}; a maximum value of β₁^{k} is set to 8;
S3: calculating a first elastic modulus Eₑ₁ of each element by a rational approximation of material properties (RAMP) method;
$${E}_{e 1} = {E}_{min} + \frac{{ρ}_{e 1}}{1 + {q}_{1} ( 1 - {ρ}_{e 1} )} ( {E}_{max} - {E}_{min} ) ;$$
wherein Eₘₐₓ is an elastic modulus of a material, and Eₘᵢₙ is a value added to avoid matrix singularity, q₁ is a first stiffness penalty factor, and q₁=4;
S4: assembling a global stiffness matrix, and calculating a structural displacement according to a static equilibrium equation;
S5: calculating a first stress σₑ₁ of each element;
S6: calculating a first von Mises stress σ_{VM1} of each element;
S7: obtaining a first penalty stress σ̅_{VM1} of each element by punishing the first von Mises stress σ_{VM1} of each element by using the RAMP method;
$${\overline{σ}}_{VM 1} = ( {E}_{min} + \frac{{ρ}_{e 1}}{1 + {q}_{2} ( 1 - {ρ}_{e 1} )} ( {E}_{max} - {E}_{min} ) ) {σ}_{VM 1} ;$$
wherein q₂ is a second stiffness penalty factor, and q₂=−0.95;
S8: obtaining an aggregate stress \tilde{σ} by aggregating the first penalty stress σ̅_{VM1} of each element;
S9: relaxing the stress constraints, wherein a formulation of stress relaxation is c·\tilde{σ}=σₗ, σₗ is a yield stress of the material; c is a relaxation coefficient in this iteration and is updated every five iterations, a formulation of c is
$$c = \frac{{\overline{σ}}_{p}^{k}}{\tilde{σ}} ,$$
σ̅ₚ^{k} is a first maximum predicted stress in this iteration;
$${\overline{σ}}_{p}^{k} = \{ \begin{matrix}{σ}_{p}^{k} , & k = 1 \\ 0.4 {σ}_{p}^{k} + 0.6 {σ}_{p}^{k - 1} , & k > 1\end{matrix} ;$$
wherein σₚ^{k} is a second maximum predicted stress, acquired by following steps:
S9.1: obtaining a second density ρₑ₂ by employing a Heaviside projection function to map the filtered density \tilde{ρ}ₑ of each element;
$${ρ}_{e 2} = \frac{tanh ( 0.5 {β}_{2}^{k} ) + tanh ( {β}_{2}^{k} ( {\tilde{ρ}}_{e} - 0.5 ) )}{2 tanh ( 0.5 {β}_{2}^{k} )} ;$$
wherein β₂^{k} is used to control the smoothness of the mapping curves; when k=1, β₂^{k}=4; iteration updates are performed every 20 times from the first iteration and the value of β₂^{k} is the last value of β₂^{k} plus 4; a maximum value of β₂^{k} is 20;
S9.2: calculating a transition factor φ:
$$φ = \frac{{N}_{b} + {N}_{w}}{N} ;$$
wherein N is a total number of elements, N_{b} is a number of elements with the second density ρₑ₂ greater than a first threshold, and N_{w} is a number of elements with the second density ρₑ₂ less than a second threshold; the first threshold is greater than 0.75, and the second threshold is less than 0.25;
S9.3: calculating the second elastic modulus Eₑ₂ of each element;
$${E}_{e 2} = \{ \begin{matrix}{E}_{min} + \frac{{ρ}_{e 2}}{1 + {q}_{1} ( 1 - {ρ}_{e 2} )} ( {E}_{max} - {E}_{min} ) , & φ < 0.9 \\ {E}_{min} + {ρ}_{e 2} ( {E}_{max} - {E}_{min} ) , & φ \geq 0.9\end{matrix} ;$$
S9.4: assembling the global stiffness matrix, and calculating the structural displacement according to the static equilibrium equation;
S9.5: calculating a second stress σₑ₂ of each element;
S9.6: calculating a second von Mises stress σ_{VM2} of each element;
S9.7: obtaining a second penalty stress σ_{VM2} of each element by punishing a second von Mises stress σ_{VM2} of each element by using a linear method;
σ̅_{VM2}=(Eₘᵢₙ+ρₑ₂(Eₘₐₓ−Eₘᵢₙ))σ_{VM2};
S9.8: calculating the second maximum predicted stress σₚ^{k} in this iteration:
σₚ^{k}=max(σ̅_{VM2});
S10: conducting a sensitivity analysis of an objective function V_{f}:
$${V}_{f} = \frac{{\sum }_{e = 1}^{N} {ρ}_{e 1} {v}_{e}}{{\sum }_{e = 1}^{N} {v}_{e}} ;$$
where vₑ is a volume of the e-th element;
S11: obtaining and storing the design variable set formed in this iteration by moving asymptote algorithm to solve optimization problem and updating the design variables of each element;
S12: judging whether this iteration meets exit iteration conditions, if this iteration meets the exit iteration conditions, exit the iteration, and record the design variable set formed in this iteration as the optimal design variable set; if the exit iteration conditions are not met, the next iteration will be carried out;
above procedures from S9.1 to S9.8 allow parallel computation with those from S2 to S8.

2. The method according to claim 1, wherein following method is used to smooth the structure according to the optimal design variable set:
for any element in the optimal design variable set, if xₑ<0.5, there is no material in a space where the element is located; if xₑ>0.5, the space where the element is located has all materials; if xₑ=0.5, the element is located at the interface.

3. The method according to claim 1, wherein in step S9.2, the first threshold value is 0.9 and the second threshold value is 0.1.

4. The method according to claim 1, wherein in step S8, the first penalty stress σ̅_{VM1} of each element is aggregated using a P-norm method.

5. The method according to claim 1, wherein in step S12, the method for judging whether this iteration meets the exit iteration conditions is to compare the design variable set formed in this iteration with the design variable set formed in the previous iteration, or compare the objective function value obtained in this iteration with the objective function value obtained in the previous iteration, and the second maximum predicted stress is less than or equal to the yield stress of the material.

6. The method according to claim 5, wherein the exit iteration condition is an absolute value of a difference between all design variables in the design variable set formed in this iteration and all design variables in the design variable set formed in the last iteration is less than the third threshold.

7. The method according to claim 6, wherein the third threshold value is 0.05.
